(19) United States
(12) Patent Application Publication
(10) Pub. No.: US 2026/0267192 A1
(43) Pub. Date: Sep. 10, 2026

(54) REARVIEW MIRROR HEATER ASSEMBLY

(71) Applicant: Gentex Corporation, Zeeland, MI (US)

(72) Inventors: James P. Dratz, Zeeland, MI (US); Taylor A. Warczinsky, Wyoming, MI (US); David J. Cammenga, Holland, MI (US)

(73) Assignee: Gentex Corporation, Zeeland, MI (US)

(21) Appl. No.: 19/166,625

(22) PCT Filed: Mar. 10, 2025
(86) PCT No.: PCT/IB2025/052552

§ 371 Date: Sep. 18, 2025

Related U.S. Application Data
(60) Provisional application No. 63/563,538, filed on Mar. 11, 2024.

(51) Int. Cl. G02F 1/153; B60R 1/06; B60S 1/02

(52) U.S. Cl. CPC G02F 1/1533; B60R 1/0602; B60S 1/026

(57) ABSTRACT

A dimmable rearview mirror assembly includes an electro-optic (“EO”) device including an EO medium that is variably transmissive in response to an applied voltage. A heating element includes a positive temperature coefficient (“PTC”) substrate, and a heater anode trace is located on and electrically coupled with the PTC substrate. An EO anode trace is located on and electrically coupled with the PTC substrate with the EO anode trace extending between an EO anode terminal and an EO anode contact.

### CROSS-REFERENCE TO RELATED APPLICATION

This application claims priority to and the benefit under 35 U.S.C. § 119(e) of U.S. Provisional Patent Application No. 63/563,538, filed on Mar. 11, 2024, entitled “REARVIEW MIRROR HEATER ASSEMBLY,” by James P. Dratz, et al., the entire disclosure of which is incorporated herein by reference.

### FIELD OF THE DISCLOSURE

The present disclosure generally relates to a system of regulating power to an electro-optic device and a heating element through a common substrate.

### SUMMARY OF THE DISCLOSURE

According to one aspect of the present disclosure, a dimmable rearview mirror assembly includes an electro-optic (“EO”) device including an EO medium that is configured to switch between a substantially transparent state, a substantially darkened state, and intermediate states in response to different applied voltages. A heating element includes a positive temperature coefficient (“PTC”) substrate, and a heater anode trace is located on and electrically coupled with the PTC substrate that includes a plurality of heater anode branches. A heater cathode trace located on and electrically coupled with the PTC substrate includes a plurality of heater cathode branches at least partially interdigitated with the heater anode branches. An EO anode trace is located on and electrically coupled with the PTC substrate and the heater anode trace through the PTC substrate.

According to another aspect of the present disclosure, a dimmable rearview mirror assembly includes a heating element having a positive temperature coefficient (“PTC”) substrate, and a heater anode trace is located on and electrically coupled with the PTC substrate. A heater cathode trace is located on and electrically coupled with the PTC substrate. An electro-optic (“EO”) anode trace is located on and electrically coupled with the PTC substrate. An EO cathode trace is located on and electrically coupled with the PTC substrate and the heater anode trace through the PTC substrate. An EO device includes a first substrate having a first surface and a second surface opposite the first surface. A second substrate has a third surface and a fourth surface opposite the third surface, where the second and third surfaces face each other to define a gap. A first electrode is coupled to the second surface and a second electrode coupled to the third surface, where at least one of the first and second electrodes are electrically coupled to the EO anode contact, and the other of the first and second electrodes is electrically coupled to the EO cathode contact. An EO medium is located between the first electrode and the second electrode that is variably transmissive based, at least in part, on an applied voltage across the EO anode contact and the EO cathode contact.

According to yet another aspect of the present disclosure, a dimmable rearview mirror assembly includes an electro-optic (“EO”) device including an EO medium that is variably transmissive in response to an applied voltage. A heating element includes a positive temperature coefficient (“PTC”) substrate, and a heater anode trace is located on and electrically coupled with the PTC substrate. An EO anode trace is located on and electrically coupled with the PTC substrate with the EO anode trace extending between an EO anode terminal and an EO anode contact.

The present disclosure generally provides a rearview mirror assembly that incorporates an electro-optic device and a heating element that defrosts and/or defogs the electro-optic device. The heating element includes a PTC substrate that generates heat through introduction of a voltage across a heater terminal. The PTC substrate is electrically coupled with the electro-optic device via one or more electro-optic traces located on the PTC substrate. A control circuit regulates the voltage across the electro-optic device to selectively change a transmissive state of the electro-optic device to a desired level. The operational combination of both the electro-optic device and the heating element may be beneficial for a reduction in part requirements, packaging limitations, and operation control optimization.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top view of a vehicle with a mirror assembly in accordance with an aspect of the present disclosure;

FIG. 2 is a schematic view of a heating assembly with heater branches in a first pattern in accordance with an aspect of the present disclosure;

FIG. 3 is a schematic view of a heating assembly with heater branches in a second pattern in accordance with an aspect of the present disclosure; and

FIG. 4 is a cross-sectional view of a mirror assembly in accordance with an aspect of the present disclosure.

### DETAILED DESCRIPTION

The present illustrated embodiments reside primarily in combinations of method steps and apparatus components related to a system of regulating power to an electro-optic device and a heating element through a common substrate. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

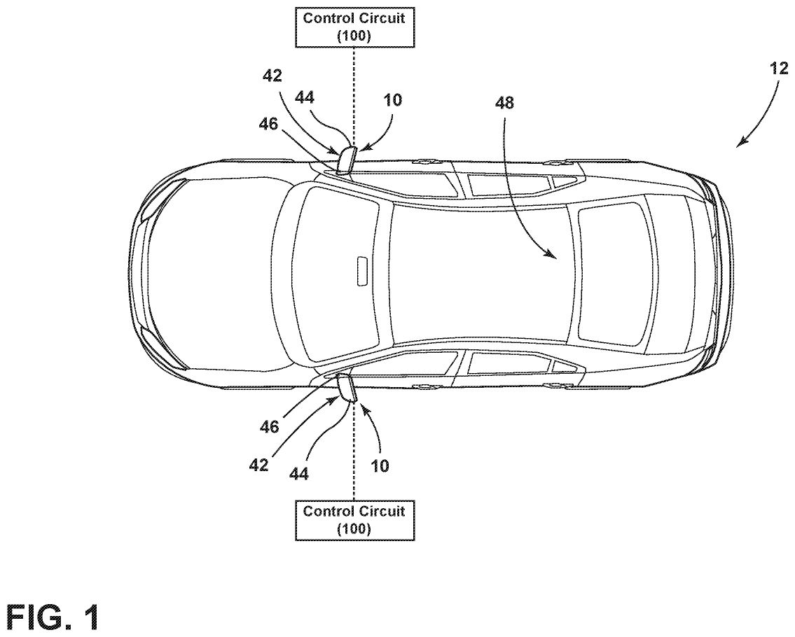

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

Referring to FIGS. 1-4, reference numeral 10 generally designates a rearview mirror assembly for a vehicle 12 that is dimmable. The rearview mirror assembly 10 includes an electro-optic (“EO”) device 14 including an EO medium 16 that is configured to switch between a substantially transparent state, a substantially darkened state, and intermediate states in response to different applied voltages. A heating element 18 includes a positive temperature coefficient (“PTC”) substrate 20, and a heater anode trace 22 is located on and electrically coupled with the PTC substrate 20 and includes a plurality of heater anode branches 24. A heater cathode trace 26 is located on and electrically coupled with the PTC substrate 20 and includes a plurality of heater cathode branches 28 at least partially interdigitated with the heater anode branches 24. An EO anode trace 30 is located on and electrically coupled with the PTC substrate 20 and the heater anode trace 22 through the PTC substrate 20.

With continued reference to FIGS. 1-4, the heating element 18 may further include an EO cathode trace 36 located on and electrically coupled with the PTC substrate 20 through the heater anode trace 22. The EO cathode trace 36 extends between an EO cathode terminal 38 and an EO cathode contact 40. In some embodiments, a control circuit 100 is operably connected to at least one (e.g., one or both) of the EO anode trace 30 and the EO cathode trace 36. The control circuit 100 may be configured to regulate a voltage applied to the EO medium 16 across the EO anode trace 30 and the EO cathode trace 36 to selectively match one of the different applied voltage requirements. In some embodiments, the EO cathode contact 40 may be operably connected to the control circuit 100 rather than or in addition to the EO anode contact 34 or the EO anode contact 34 may be operably connected to the control circuit 100 rather than or in addition to the EO cathode contact 40. In this manner, because the EO anode trace 30 and the EO cathode trace 36 are located on the PTC substrate 20, when voltage is applied across the heater anode trace 22 and the heater cathode trace 26, current flows between the heater anode trace 22 and the EO anode trace 30 and the heater anode trace 22 and the EO cathode trace 36. Therefore, in some embodiments, the control circuit 100 may be configured to regulate the current and/or the applied voltage from the EO cathode trace 36 rather than or in addition to the EO anode trace 30 (or vice versa) to manage the applied voltage received by the EO device 14 across the EO anode trace 30 and the EO cathode trace 36. However, in some embodiments, the EO cathode trace 36 may be grounded (e.g., at the EO cathode contact 40) and, therefore, the current that passes through the PTC substrate 20 may be grounded and not require management by the control circuit 100. In other words, it should be appreciated that at least one or both of the EO anode trace 30 and the EO cathode trace 36 may require management, intervention, and/or dynamic drainage from the control circuit 100 based on the amount of current flowing from the PTC substrate 20 and the heater anode trace 22. Generally speaking, the heating element 18 may have a high applied voltage requirement and the EO device 14 may have a low applied voltage requirement relative to the heating element 18 that corresponds to the different transmissive states. In this manner, the applied voltage that is received by the EO device 14 across the EO anode trace 30 and the EO cathode trace 36 may require management, intervention, and/or dynamic drainage from the control circuit 100 to prevent overpowering and/or otherwise incidentally or automatically powering the EO device 14 when the heating element 18 is powered. The applied voltage may be increased or decreased for obtaining certain transmissive states (e.g., the substantially transparent state, intermediate states, substantially darkened states). In this manner, because both the EO anode trace 30 and the EO cathode trace 36 may be receiving substantial current through the PTC substrate 20, intervention by the control circuit 100 may be necessary to selectively match one of the different applied voltage requirements. It should be appreciated that when the applied voltage may be zero (e.g., in the substantially transparent state), there is no applied voltage across the EO anode trace 30 and the EO cathode trace 36.

As used herein the terms “high” and “low” are used to designate respective proportional relationships between each other and do not impart absolute values. In other words, a high applied voltage may be any value, including values that may be traditionally considered small, and a low applied voltage will be less than the high applied voltage. Likewise, the low applied voltage may be any value, including values that may be traditionally considered large or an absence of an applied voltage, but the high applied voltage will be greater. In this manner, while various examples are provided with these terms, it should be appreciated that either of these high and low values may be any value, including zero, as long as the high applied voltage is greater than the low applied voltage. In some examples, the high applied voltage requirements of the heating element 18 may be about 48 V or less, about 13 V, or about 12 V. For example, the high applied voltage across the heater anode trace 22 and the heater cathode trace 26 may be about 12 V (e.g., 12 V-0.0 V or 6 V-6 V). The electro-optic device 14, on the other hand, may be configured to operate within a lower applied voltage between about 1.3 V and 0.8 V (e.g., across EO anode and cathode traces 30, 36) to obtain the substantially darkened state. Smaller applied voltage values may be proportional to the amount of transmissiveness. However, these examples are provided as illustrative only and other differences and values can be utilized without departing from the scope of the subject disclosure.

The terms “anode” may refer to a component (e.g., a trace and/or a terminal) of the assembly 10 that includes a higher voltage potential and the term “cathode” may refer to a component (e.g., a trace and/or a terminal) of the assembly 10 that includes a lower voltage potential(e.g., ground). In other words, the terms anode and cathode as used herein when designating a component (e.g., a trace and/or a terminal) are meant to designate which components include higher or lower potentials, where the difference is equal to the applied voltage. Therefore, the terms are used to emphasize relative differences and not absolute values.

With still continued reference to FIGS. 1-4, the rearview mirror assembly 10 is configured to operate under a number of conditions. More particularly, the heating element 18 is configured to defrost or defog the EO device 14. The EO medium 16, on the other hand, switches between various degrees of transmissiveness and/or reflectiveness based on changes to the applied voltage. It should be appreciated that the term electro-optic and electrochromic may be exchangeable throughout for various types of dimmable applications. In operation, it may be beneficial to power the heating element 18 without the EO device 14, power the EO device 14 without the heating element 18, or power both the heating element 18 and the EO device 14 simultaneously. However, because the EO anode trace 30 and the EO cathode trace 36 are located on and electrically coupled with the electrically conductive PTC substrate 20, without the control circuit 100, and when the heating element 18 (e.g., the heater anode trace 22) is powered, the EO device 14 (e.g., the EO medium) can consequently and inadvertently receive the applied voltage and switch transmissiveness and/or be damaged by a higher applied voltage than required. Therefore, as will be described in greater detail below, the control circuit 100 may be configured to dynamically regulate the applied voltage across the EO anode trace 30 and the EO cathode trace 36 in situations where it is beneficial to power the heating element 18 without the EO device 14. In addition, it will be described in greater detail below that the control circuit 100 may be further configured to regulate (e.g., reduce applied voltage across the EO anode trace 30 and the EO cathode trace 36) in situations where it is beneficial to power both the heating element 18 and the EO device 14, based on scenarios where the heating element 18 has higher applied voltage requirements. The PTC substrate 20 may include PTC material located on a backer/carrier. Generally speaking, electrically coupled with the PTC substrate 20 should be understood to mean with the PTC material (e.g., not the backer/carrier).

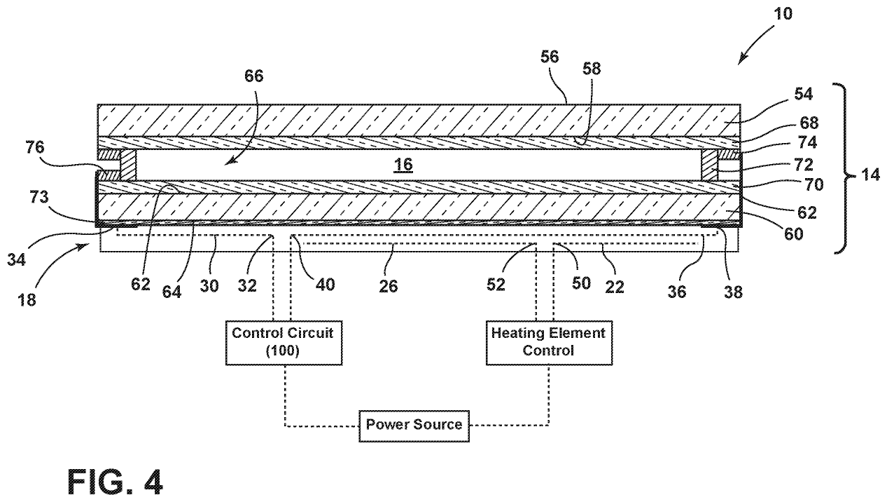

While the control circuit 100 in FIG. 4 is depicted as only controlling the EO device 14, it should be appreciated that, in some embodiments, both the heating element 18 and the EO device 14 may be controlled by the control circuit 100. In some embodiments, both the heating element 18 and the EO device 14 receive power/voltage from a singular power source (e.g., from a power system of the vehicle 12). However, it should be appreciated that both the heating element 18 and the EO device 14 may receive power from different power sources. In some embodiments, the control circuit 100 may be operably connected to both the EO anode trace 30 and the EO cathode trace 36 and configured to control and/or regulate applied voltage across the EO anode trace 30 and the EO cathode trace 36. In some implementations, the EO cathode trace 36 and the heater cathode trace 26 could be common (e.g., shorted together) and the control circuit 100 may be electrically coupled between the EO anode trace 30 and common heater/EC cathode 26, 36.

The heater anode and cathode traces 22, 26 are applied to and are electrically coupled with the PTC substrate 20. During operation, the PTC substrate 20 typically self-regulates by having a lower resistance at colder temperatures, and an increasing resistance (e.g., proportionally) at higher temperatures. When the heating element 18 is activated, current flows from the heater anode trace 22, through the PTC substrate 20, and then to the heater cathode trace 26. In some implementations, most of the heat is generated in the PTC substrate 20 for the temperature regulation functionality (e.g., defogging). Once the PTC substrate 20 is warmed, the current drops and the power of the heating element 18 also consequently drops. In some embodiments, the rearview mirror assembly 10 may be configured to apply about 13 V across the two heater terminals 50, 52 when the control circuit 100 calls for heating the rearview mirror assembly 10, which may vary based on ambient temperature, other environmental conditions, etc. Because the EO anode trace 30 and the EO cathode trace 36 are located on and also electrically coupled with the PTC substrate 20, without additional control, the EO device 14 receives voltage in accordance with the fluctuating resistance of the PTC substrate 20. In this manner, the control circuit 100 may be described as configured to dynamically regulate the applied voltage across the EO anode trace 30 and the EO cathode trace 38 as needed. As the resistance of the PTC substrate 20 fluctuates, the control circuit 100 controls the applied voltage to the EO device 14. While it is contemplated that the EO anode trace 30 could be conductively isolated from the PTC substrate 20, such an isolation may ultimately create cold spots and uneven temperature regulation across the heating element 18 as the isolation could result in removal of portions in the PTC substrate 20 to accommodate the isolated space for the EO anode and cathode traces 30, 36.

The rearview mirror assembly 10 may be configured to obtain several operational states. In a first state, the rearview mirror assembly 10 is warmed but not dimmed. In the first state, the heating element 18 may be powered and control circuit 100 may manage the applied voltage to the EO device 14 to an applied voltage requirement of zero, where the EO anode trace 30 and the EO cathode trace 36 are both controlled by the same electrical potential. In a second state, the rearview mirror assembly 10 is dimmed but may not be warmed to an operational temperature (e.g., a defogging temperature). In this manner, the applied voltage across the heater anode trace 22 and the heater cathode trace 26 may meet one of the different applied voltage requirements. In a third state, the rearview mirror assembly 10 is warmed and dimmed. In the third state, the heating element 18 may be powered and control circuit 100 may manage the applied voltage to the EO device 14 to an applied voltage requirements of a desired level of transmissiveness. The value of the applied voltage may be proportional to the level of dimming or darkening.

With reference now specifically to FIG. 1, the rearview mirror assembly 10 may be incorporated in various structures. For example, the rearview mirror assembly 10 may be incorporated in a side mirror 42 (e.g., a pair of side mirrors 42) for connection to one or more sides of the vehicle 12. For example, the side mirror 42 may include a housing 44 and a mounting member 46 that connects the housing 44 to an exterior 48 (e.g., side) of the vehicle 12. However, it should be appreciated that the rearview mirror assembly 10 may be incorporated into any other structure (e.g., an aircraft, water vessel, architecture) that includes a mirror or window with two or more of a heating system, an EO component, and/or another accessory that can be powered through the PTC substrate 20.

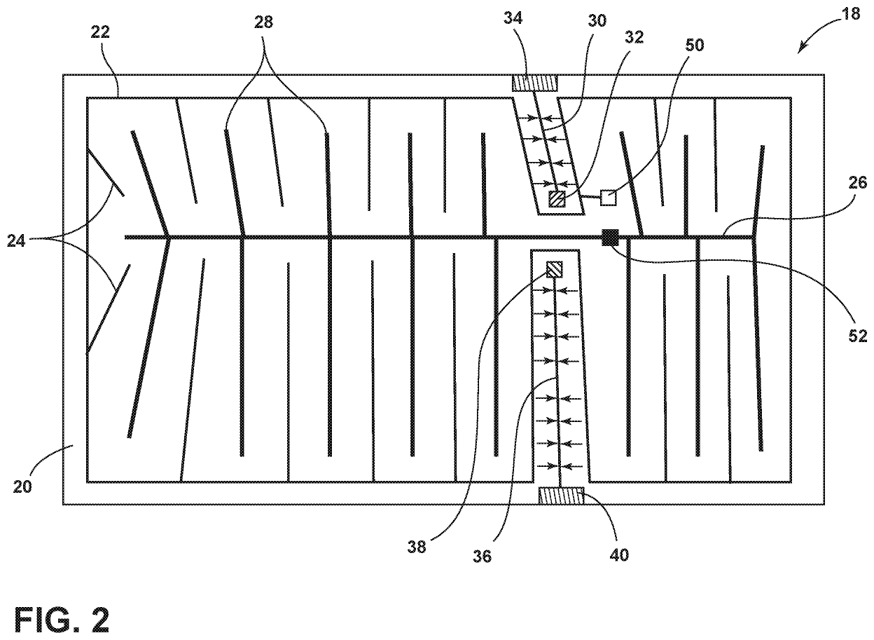

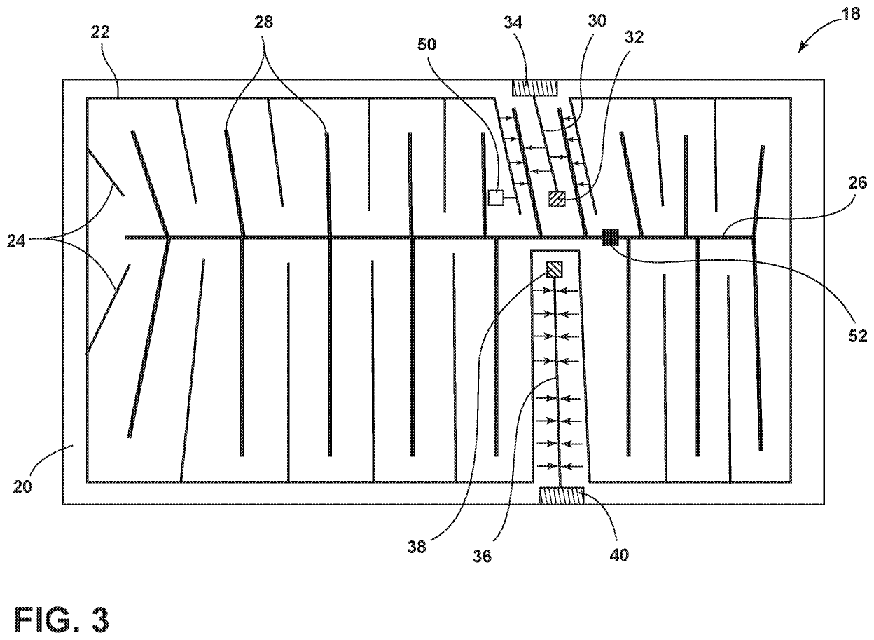

With reference now to FIGS. 2 and 3, the heater traces 22, 26 may have a variety of patterns, particularly relative to the EO anode and cathode traces 30, 36. It should be appreciated that the depictions in FIGS. 2 and 3 are exemplary in nature. As such, in some embodiments, the heater traces 22, 26 may not include branches 24, 28 and, instead, may employ segments (e.g., continuous traces 22, 26 with segmentations having different shapes, loops, and/or the like) in a variety of patterns. For example, the heater anode and cathode traces 22, 26 may alternatively include segments that extend in serpentine-type loops, spirals, and other patterns. The heater anode and cathode traces 22, 26 may generally extend parallel to one another and/or in close proximity to one another. Further, in implementations that employ the branches 24, 28, the location, number, and distribution of the branches 24, 28 may be different than those depicted in FIGS. 2 and 3. In addition, in some implementations, the branches 24, 28 may include forks or bifurcations with sub-branches extending therefrom. In such embodiments, the heater anode and cathode traces 22, 26 are located on and may extend along the PTC substrate 20 in any pattern that facilitates heating the PTC substrate 20. When the heater traces 22, 26 do not include branches 24, 28, the EO anode and/or cathode traces 30, 36 may be located between the heater anode trace 22 and the heater cathode trace 26, adjacent to the heater anode trace 22, surrounding on two or more sides by the heater anode trace 22, and/or surrounded on one or more sides by the heater cathode trace 26. Therefore, regardless of the proximity of the EO anode and cathode traces 30, 36 to the heater anode trace 22, the control circuit 100 can regulate the applied voltage based on known applied voltage requirements of the EO device 14.

With continued reference to FIGS. 2 and 3, the branches 24, 28 are depicted as straight and interdigitated. However, it should be appreciated that in embodiments including the branches 24, 28, the branches may have other shapes, including non-linear shapes such as serpentine, curved, angled, combinations thereof, and/or the like. Likewise, in some embodiments, the branches 24, 28 may not be or may not completely be interdigitated. When the heater traces 22, 26 (e.g., the heater anode trace 22) include branches 24, 28, the anode and/or EO cathode traces 30, 36 may be located between one of the heater anode branches 24 and one of the heater cathode branches 28, adjacent to one of heater anode branches 24, surrounding on two or more sides one or more of the heater anode branches 24, and/or surrounded on one or more sides by one or more of the heater cathode branches 28. However, generally speaking, at least one of the EO anode and cathode traces 30, 36 may require management of the applied voltage and/or current.

With reference now to FIG. 2 a first example pattern is depicted, where the EO anode trace 30 is located adjacent to at least one (e.g., two) of the heater anode branches 24. As depicted, the EO cathode trace 36 may also be located between a different pair of the heater anode branches 24. In the arrangement depicted in FIG. 2, the arrows that are pointed to the EO traces 30, 36 indicate the current that passes through the PTC substrate 20. The pattern of the heater traces 22, 26 may be beneficial over other arrangements as the heater anode is typically held at a higher voltage relative to both the EO anode trace 30 and EO cathode trace 36 and therefore limits cold spots.

FIG. 3 depicts a second pattern, where the EO anode trace 30 is located adjacent to at least one (e.g., two) of the heater cathode branches 28. In some embodiments, the EO cathode trace 36 may also be located between a different pair of the heater cathode branches 28 or adjacent to any one of the heater cathode branches 28. In the arrangement depicted in FIG. 3, the arrows that are pointed to the EO traces 30, 36 indicate the current that passes through the PTC substrate 20 when both the EO device 14 and the heating element 18 are energized. The pattern of the heater traces 22, 26 may be beneficial over other arrangements as the heater cathode branches 28 consume, absorb, or drain at least part of the current that passes through the PTC substrate 20 (e.g., between the heater anode branches 24 and the EO anode trace 30, when they are respectively energized). However, because the electric potential of the EO traces 30, 36 are similar to the electric potential of the heater cathode branch 28, little current will flow between them and cold spots can be present. To accommodate for the potential cold spots, the pairs of the heater cathode branches 28 may be in close proximity to the EO traces 30, 36 with heater anode branches 24 in close proximity to the pairs of heater cathode branches 28 opposite the EO traces 30, 36.

With reference to the specific examples depicted in both FIGS. 2 and 3, it should be appreciated that other patterns and relative locations of the various traces and components may be utilized. For example, in some embodiments, the EO traces 30, 36 may be located between one heater anode branch 24 and one heater cathode branch 28, which may result in a combination of the above-described benefits of the first and second patterns. While other patterns may be utilized without departing from the scope of the subject disclosure, it should generally be appreciated that, regardless of the pattern, the control circuit 100 can regulate the applied voltage to match any one of the different applied voltage requirements to obtain a desired transmissive state. It should also be appreciated that the heater anode trace 22 may include a heater anode terminal 50 that receives power from a power source and the heater cathode trace 26 may include a heater cathode terminal 52 that receives power from a power source and/or the heater anode trace 22 (e.g., grounds voltage from the heater anode trace 22).

With reference now to FIG. 4, the EO device 14 includes a first substrate 54 having a first surface 56 and a second surface 58 opposite the first surface 56. A second substrate 60 has a third surface 62 and a fourth surface 64 opposite the third surface 62. The second and third surfaces 58, 62 face each other to define a gap 66. A first electrode 68 is coupled to the second surface 58, and a second electrode 70 is coupled to the third surface 62. The EO medium 16 is located between the first electrode 68 and the second electrode 70. In some embodiments, the first substrate 54 may define a front surface or viewing area of the rearview mirror assembly 10. In other embodiments, additional substrates (not shown) may be coupled to the first substrate 54 and define the viewing area. The EO medium 16 may be retained within the gap 66 via a seal 72 that extends along a perimeter of the EO device 14. In some embodiments, a reflective layer 73 may be located on an opposite side of the EO medium 16 than the viewing surface (e.g., on the fourth surface 64) that causes the rearview mirror assembly 10 to be reflective when the EO medium 16 is not fully darkened.

A first electrical member 74 (e.g., a bus or a conductive clip) may be connected to the first electrode 68, and a second electrical member 76 (e.g., a bus or a conductive clip) may be connected to the second electrode 70. More particularly, the electrical members 74, 76 may provide voltage to the electrodes 68, 70. A concealment layer (not shown), such as an opaque ring or a chrome ring may be located between the seal 72 and the first substrate 54. The EO medium 16 may be configured as any electroactive medium and may be configured under the principles of liquid crystal technology, may include an anode and a cathode, or may be any other type of substance or collection of substances that change transmissiveness in response to an applied voltage. In some implementations, the EO medium 16 may be solution-phase and include one or more anodic and cathodic species. In some implementations, the EO medium 16 may be solid-state and include a thin-film-electrolyte (“TFE”) sandwiched between an anodic and a cathodic film. The EO anode trace 30 may be electrically coupled to one of the electrodes 68, 70 (e.g., one of the electrical members 74, 76) and the EO cathode trace 36 may be electrically coupled to a different one of the electrodes 68, 70 (e.g., a different one of the electrical members 74, 76).

With reference back to FIGS. 1-4, the control circuit 100 may have a variety of configurations, for example, the control circuit 100 may be configured as an electric control unit having a memory and a process, the memory containing instructions that, when executed by the processor, cause the processor to perform the functions described herein. For example, the memory may include instructions that cause the processor to determine a current status of the heating element 18 (e.g., on or off) and a current status of the EO device 14 (e.g., on or off) and regulate the applied voltage across the EO anode trace 30 and the EO cathode trace 36. The control circuit 100 may alternatively include a logic scheme with an electronic component that exhibits variable resistance (e.g., a variable resistance element). More particularly, the variable resistance element (e.g., a transistor, such as an NPN transistor) may have a varying resistance to achieve a steady voltage regardless of how much current is flowing out of, or into the transistor, thus regulating applied voltage across the EO anode trace 30 and the EO cathode trace 36. In some embodiments, the variably resistive element may include or be configured as MOSFETS, transistors, PNP BJTS, Op-Amps, DAC, the like, and/or combinations thereof. In still further embodiments, the control circuit 100 may include a combination of logic components (e.g., jumpers, resistors, transistors, capacitors, and/or the like) as well as the electric control unit. In scenarios where the EO device 14 needs to be energized, the applied voltage may originate from the power source. Generally speaking, the EO device 14 may have lower applied voltage requirements than the heating element 18 and, therefore, in situations where both the EO device 14 and the heating element 18 need to be energized, EO device 14 may be directly powered from a power source while any current and/or applied voltage from the PTC substrate 20 to the EO device 14 is dynamically regulated from the EO anode trace 30 and/or the EO cathode trace 36 to the EO medium 16.

The disclosure herein is further summarized in the following paragraphs and is further characterized by combinations of any and all of the various aspects described therein.

According to one aspect of the present disclosure, a dimmable rearview mirror assembly includes an electro-optic (“EO”) device including an EO medium that is configured to switch between a substantially transparent state, a substantially darkened state, and intermediate states in response to different applied voltages. A heating element includes a positive temperature coefficient (“PTC”) substrate. A heater anode trace is located on and electrically coupled with the PTC substrate that includes a plurality of heater anode branches. A heater cathode trace located on and electrically coupled with the PTC substrate includes a plurality of heater cathode branches at least partially interdigitated with the heater anode branches. An EO anode trace is located on and electrically coupled with the PTC substrate and the heater anode trace through the PTC substrate.

According to one aspect, an EO anode trace is located adjacent to at least one of the heater anode branches.

According to yet another aspect, an EO anode trace is located between two heater anode branches.

According to still another aspect, the heating element further includes an EO cathode trace located on and electrically coupled with the PTC substrate and the heater anode trace through the PTC substrate.

According to another aspect, a control circuit is operably connected to at least one of the EO anode trace the EO cathode trace, and the control circuit is configured to regulate a voltage applied to the EO medium across the EO anode trace and the EO cathode trace to selectively match one of the different applied voltage requirements.

According to yet another aspect, an EO anode trace is located adjacent to at least one heater cathode branches.

According to yet another aspect, an EO anode trace is located adjacent to and between two heater cathode branches.

According to still another aspect, a control circuit includes a variable resistance element.

According to another aspect of the present disclosure, a dimmable rearview mirror assembly includes a heating element having a positive temperature coefficient (“PTC”) substrate, and a heater anode trace is located on and electrically coupled with the PTC substrate. A heater cathode trace is located on and electrically coupled with the PTC substrate. An electro-optic (“EO”) anode trace is located on and electrically coupled with the PTC substrate. An EO cathode trace is located on and electrically coupled with the PTC substrate and the heater anode trace through the PTC substrate. An EO device includes a first substrate having a first surface and a second surface opposite the first surface. A second substrate has a third surface and a fourth surface opposite the third surface, where the second and third surfaces face each other to define a gap. A first electrode is coupled to the second surface and a second electrode coupled to the third surface, where at least one of the first and second electrodes are electrically coupled to the EO anode contact and the other of the first and second electrodes is electrically coupled to the EO cathode contact. An EO medium is located between the first electrode and the second electrode that is variably transmissive based, at least in part, on an applied voltage across the EO anode contact and the EO cathode contact.

According to another aspect, the heater anode trace includes a plurality of heater anode branches.

According to still another aspect, the heater cathode trace includes a plurality of heater cathode branches at least partially interdigitated with the heater anode branches.

According to yet another aspect, an EO anode trace is located adjacent to at least one of the heater anode branches.

According to yet another aspect, an EO anode trace is located adjacent to and between two of the heater anode branches.

According to still another aspect, the EO anode trace is located adjacent to at least one of the heater cathode branches.

According to another aspect, a control circuit is operably connected to at least one of the EO anode contact and the EO cathode contact, and the control circuit is configured to regulate the applied voltage across the EO anode contact and the EO cathode contact to obtain a desired transmissive state of the EO medium.

According to still another aspect, a housing at least partially contains the EO device and the heating element, and a mounting member is configured to couple the rearview mirror assembly to a side of a vehicle.

According to yet another aspect of the present disclosure, a dimmable rearview mirror assembly includes an electro-optic (“EO”) device including an EO medium that is variably transmissive in response to an applied voltage. A heating element includes a positive temperature coefficient (“PTC”) substrate, and a heater anode trace is located on and electrically coupled with the PTC substrate. An EO anode trace is located on and electrically coupled with the PTC substrate with the EO anode trace extending between an EO anode terminal and an EO anode contact.

According to another aspect, the heating element further includes an EO cathode trace located on and electrically coupled with the PTC substrate and the heater anode trace through the PTC substrate.

According to yet another aspect, a control circuit is operably connected to at least one of the EO anode trace and the EO cathode trace, and the control circuit is configured to regulate a voltage applied to the EO medium across the EO anode trace and the EO cathode trace to obtain a desired transmissive state.

According to still yet another aspect, the heater anode trace includes a plurality of heater anode branches and a heater cathode trace that includes a plurality of heater cathode branches at least partially interdigitated with the heater anode branches.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

1. A dimmable rearview mirror assembly, comprising;
an electro-optic (“EO”) device including an EO medium that is configured to switch between a substantially transparent state, a substantially darkened state, and intermediate states in response to different applied voltage;
a heating element including:
a positive temperature coefficient (“PTC”) substrate;
a heater anode trace located on and electrically coupled with the PTC substrate including a plurality of heater anode branches;
a heater cathode trace located on and electrically coupled with the PTC substrate including a plurality of heater cathode branches at least partially interdigitated with the heater anode branches; and
an EO anode trace located on and electrically coupled with the PTC substrate and the heater anode trace through the PTC substrate.

2. The dimmable rearview mirror assembly of claim 1, wherein the EO anode trace is located adjacent to at least one of the heater anode branches.

3. The dimmable rearview mirror assembly of claim 2, wherein the EO anode trace is located adjacent to and between two of the heater anode branches.

4. The dimmable rearview mirror assembly of claim 1, wherein the heating element further includes an EO cathode trace located on and electrically coupled with the PTC substrate and the heater anode trace through the PTC substrate.

5. The dimmable rearview mirror assembly of claim 4, wherein a control circuit is operably connected to at least one of the EO anode trace the EO cathode trace, and the control circuit is configured to regulate a voltage applied to the EO medium across the EO anode trace and the EO cathode trace to selectively match one of the different applied voltage requirements.

6. The dimmable rearview mirror assembly of claim 1, wherein the EO anode trace is located adjacent to at least one of the heater cathode branches.

7. The dimmable rearview mirror assembly of claim 6, wherein the EO anode trace is located adjacent to and between two of the heater cathode branches.

8. The dimmable rearview mirror assembly of claim 1, wherein the control circuit includes a variable resistance element.

9. A dimmable rearview mirror assembly, comprising;
a heating element including:
a positive temperature coefficient (“PTC”) substrate;
a heater anode trace located on and electrically coupled with the PTC substrate;
a heater cathode trace located on and electrically coupled with the PTC substrate;
an electro-optic (“EO”) anode trace located on and electrically coupled with the PTC substrate and the heater anode trace through the PTC substrate; and
an EO cathode trace located on and electrically coupled with the PTC substrate and the heater anode trace through the PTC substrate;
an EO device including:
a first substrate having a first surface and a second surface opposite the first surface;
a second substrate having a third surface and a fourth surface opposite the third surface, the second and third surfaces facing each other to define a gap;
a first electrode coupled to the second surface and a second electrode coupled to the third surface, wherein at least one of the first and second electrodes are electrically coupled to the EO anode contact and the other of the first and second electrodes is electrically coupled to the EO cathode contact; and
an EO medium located between the first electrode and the second electrode that is variably transmissive based, at least in part, on an applied voltage across the EO anode contact and the EO cathode contact.

10. The dimmable rearview mirror assembly of claim 9, wherein the heater anode trace includes a plurality of heater anode branches.

11. The dimmable rearview mirror assembly of claim 10, wherein the heater cathode trace includes a plurality of heater cathode branches at least partially interdigitated with the heater anode branches.

12. The dimmable rearview mirror assembly of claim 11, wherein the EO anode trace is located adjacent to at least one of the heater anode branches.

13. The dimmable rearview mirror assembly of claim 12, wherein the EO anode trace is located adjacent to and between two of the heater anode branches.

14. The dimmable rearview mirror assembly of claim 11, wherein the EO anode trace is located adjacent to at least one of the heater cathode branches.

15. The dimmable rearview mirror assembly of claim 9, wherein a control circuit is operably connected to at least one of the EO anode contact and the EO cathode contact, and the control circuit is configured to regulate the applied voltage across the EO anode contact and the EO cathode contact to obtain a desired transmissive state of the EO medium.

16. The dimmable rearview mirror assembly of claim 9, further including a housing at least partially containing the EO device and the heating element, and a mounting member is configured to couple the dimmable rearview mirror assembly to a side of a vehicle.

17. A dimmable rearview mirror assembly, comprising;
an electro-optic (“EO”) device including an EO medium that is variably transmissive in response to an applied voltage;
a heating element including:
a positive temperature coefficient (“PTC”) substrate;
a heater anode trace located on and electrically coupled with the PTC substrate; and
an EO anode trace located on and electrically coupled with the PTC substrate, the EO anode trace extending between an EO anode terminal and an EO anode contact.

18. The dimmable rearview mirror assembly of claim 17, wherein the heating element further includes an EO cathode trace located on and electrically coupled with the PTC substrate and the heater anode trace through the PTC substrate.

19. The dimmable rearview mirror assembly of claim 18, wherein a control circuit is operably connected to at least one of the EO anode trace the EO cathode trace, and the control circuit is configured to regulate a voltage applied to the EO medium across the EO anode trace and the EO cathode trace to obtain a desired transmissive state.

20. The dimmable rearview mirror assembly of claim 17, wherein the heater anode trace includes a plurality of heater anode branches and a heater cathode trace that includes a plurality of heater cathode branches at least partially interdigitated with the heater anode branches.
